(19) United States
(12) Patent Application Publication
(10) Pub. No.: US 2025/0054948 A1
(43) Pub. Date: Feb. 13, 2025

(54) CATHODE ACTIVE MATERIAL HAVING CONTROLLED RHEOLOGICAL PROPERTIES FOR A LITHIUM SECONDARY BATTERY

(71) Applicants: HYUNDAI MOTOR COMPANY, Seoul (KR); KIA CORPORATION, Seoul (KR); WONIK QnC CORPORATION, Gumi-si (KR)

(72) Inventors: Je Sik Park, Seoul (KR); Hong Seok Min, Yongin-si (KR); Sung Woo Noh, Seoul (KR); Jeong Hyun Seo, Daejeon (KR); Im Sul Seo, Cheongju-si (KR); Ju Yeong Seong, Seongnam-si (KR); Chung Bum Lim, Suwon-si (KR); Hyuk Chun Kwon, Gumi-si (KR); Ho Chang Lee, Daegu (KR); Seong Uk Oh, Daegu (KR); Ji Su Kim, Gumi-si (KR); Jong Hyun Park, Gumi-si (KR)

(73) Assignees: HYUNDAI MOTOR COMPANY, Seoul (KR); KIA CORPORATION, Seoul (KR); WONIK QnC CORPORATION, Gumi-si (KR)

(21) Appl. No.: 18/529,028

(22) Filed: Dec. 5, 2023

(30) Foreign Application Priority Data
Aug. 8, 2023 (KR) 10-2023-0103669

(51) Int. Cl. H01M 4/36; C01B 25/30; C01B 33/32; C01G 25/00; C01G 33/00; C01G 53/00; H01M 4/485; H01M 4/505; H01M 4/525

(52) U.S. Cl. CPC H01M 4/366; C01B 25/30; C01B 33/32; C01G 25/00; C01G 33/00; C01G 53/50; H01M 4/485; H01M 4/505; H01M 4/525; C01P 2004/03; C01P 2006/40

(57) ABSTRACT

A cathode active material with controlled rheological properties for lithium secondary batteries. In particular, the cathode active material for a lithium secondary battery includes: a core part comprising a lithium metal oxide; and a coating layer covering at least a portion of a surface of the core part and comprising an inorganic compound.

### CROSS REFERENCE TO RELATED APPLICATION

The present application claims priority to Korean Patent Application No. 10-2023-0103669, filed Aug. 8, 2023, the entire content of which is incorporated herein for all purposes by this reference.

### BACKGROUND

### 1. Field

The present disclosure relates to a cathode active material with controlled rheological properties for lithium secondary batteries.

### 2. Description of the Related Art

Rechargeable secondary batteries are used not only in small electronic devices such as mobile phones and laptops but also in large vehicles such as hybrid vehicles and electric vehicles. Accordingly, there is a need to develop a secondary battery having higher stability and energy density.

Existing secondary batteries are mostly composed of cells based on organic solvents (e.g., organic liquid electrolytes), so there are limitations in improving stability and energy density of the existing secondary batteries.

All-solid-state batteries using solid electrolytes have recently attracted attention because these batteries are based on a technology that does not use organic solvents and thus the cells thereof can be manufactured in a safer and simpler form.

The statements in this Background section merely provide background information related to the present disclosure and may not constitute prior art.

### SUMMARY

The present disclosure provides a cathode active material with controlled rheological properties and excellent dispersibility for lithium secondary batteries.

The objectives of the present disclosure are not limited to the objective described above. The above and other objectives of the present disclosure become more apparent from the following description and are realized by means recited in the claims and combinations of the means.

According to an embodiment of the present disclosure, a cathode material for a lithium secondary battery may include: a core part containing a lithium metal oxide; and a coating layer that covers at least a portion of the surface of the core part and includes an inorganic compound.

The cathode active material may have a flow angle in a range of 20° to 55°.

The cathode active material may have a cohesive index in a range of 10 to 20.

The cathode active material may have a roughness index in a range of 1.30 to 1.50.

The cathode active material may have a coefficient of surface friction in a range of 0.8 to 1.2.

The core part may contain a compound represented by Formula 1:

Liₐ(NiₓM1_{y}M2_{z})O₂ [Formula 1]

Within Formula 1, M1 may include Co, Mn, Ni, Al, Mg, or Ti; M2 may include Ca, Mg, Al, Ti, Sr, Fe, Co, Mn, Ni, Cu, Zn, Y, Zr, Nb, or B; and 0<a≤1, 0.7≤x≤1, 0≤y≤0.3, 0≤z≤0.3, and x+y+z=1 may be satisfied.

The coating layer may include LiNbO₃, Li₂ZrO₃, Li₃PO₄, Li₂SiO₃, or combinations thereof.

The cathode active material may include 90% to 99% by weight of the core part and 1% to 10% by weight of the coating layer.

According to the present disclosure, a cathode active material with controlled rheological properties and excellent dispersibility for lithium secondary batteries can be obtained.

According to the present disclosure, a lithium secondary battery having a prolonged lifespan can be obtained.

The effect and advantages of the present disclosure are not limited to the ones described above. The effects of the present disclosure should be understood to include all effects that can be inferred from the following description.

### BRIEF DESCRIPTION OF THE DRAWINGS

In order that the disclosure may be well understood, there are now described various forms thereof, given by way of example, reference being made to the accompanying drawings, in which:

FIG. 1 shows a lithium secondary battery cathode active material according to one embodiment of the present disclosure;

FIG. 2 shows an example of a device capable of measuring the fluidity of a lithium secondary battery cathode active material for according to the present disclosure;

FIG. 3 shows an example of a method of measuring a flow angle;

FIG. 4A shows an SEM analysis result of a cathode active material according to Comparative Example;

FIG. 4B shows an SEM analysis result of a cathode active material according to Example 1;

FIG. 4C shows an SEM analysis result of a cathode active material according to Example 2;

FIG. 4D shows an SEM analysis result of a cathode active material according to Example 3;

FIG. 4E shows an SEM analysis result of a cathode active material according to Example 4;

FIG. 4F shows an SEM analysis result of a cathode active material according to Example 5;

FIG. 4G shows an SEM analysis result of a cathode active material according to Example 6;

FIG. 4H shows an SEM analysis result of a cathode active material according to Example 7;

FIG. 5A shows a flow angle measurement result of a cathode active material according to Comparative Example;

FIG. 5B shows a flow angle measurement result of the cathode active material according to Example 1;

FIG. 5C shows a flow angle measurement result of the cathode active material according to Example 2;

FIG. 5D shows a flow angle measurement result of the cathode active material according to Example 3; and

FIG. 5E shows a flow angle measurement result of the cathode active material layer according to Example 4.

The drawings described herein are for illustration purposes only and are not intended to limit the scope of the present disclosure in any way.

### DETAILED DESCRIPTION

Above objectives, other objectives, features, and advantages of the present disclosure are readily understood from the embodiments described below and the accompanying drawings. However, the present disclosure is not limited to the embodiments described herein and may be embodied in other forms. The embodiments described herein are provided so that the disclosure can be made thorough and complete and that the spirit of the present disclosure can be fully conveyed to those skilled in the art.

Throughout the drawings, like elements are denoted by like reference numerals. In the accompanying drawings, the dimensions of the structures are larger than actual sizes for clarity. Terms used in the specification, “first,” “second,” etc., may be used to describe various components, but the components are not to be construed as being limited to the terms. These terms are used only for the purpose of distinguishing a component from another component. For example, without departing from the scope of the present disclosure, a first component may be referred as a second component, and a second component may be also referred to as a first component. As used herein, the singular forms “a,” “an,” and “the” are intended to include plural forms as well unless the context clearly indicates otherwise.

It should be further understood that the terms “comprises,” “includes,” or “has” when used in this specification specify the presence of stated features, regions, integers, steps, operations, elements and/or components, but do not preclude the presence or addition of one or more other features, regions, integers, steps, operations, elements, components and/or combinations thereof. Similarly, when an element such as a layer, film, area, or sheet is referred to as being “on” another element, it can be directly under the other portion, or intervening elements may be present therebetween. Similarly, when a portion of an element such as a layer, film, area, or sheet is referred to as being “under” another element, it can be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Additionally, where a numerical range is disclosed herein, such range is continuous and, unless otherwise indicated, includes all values from the minimum to the maximum of such range inclusively. Moreover, when such a range pertains to integer values, all integers including the minimum value to the maximum value are included, unless otherwise indicated.

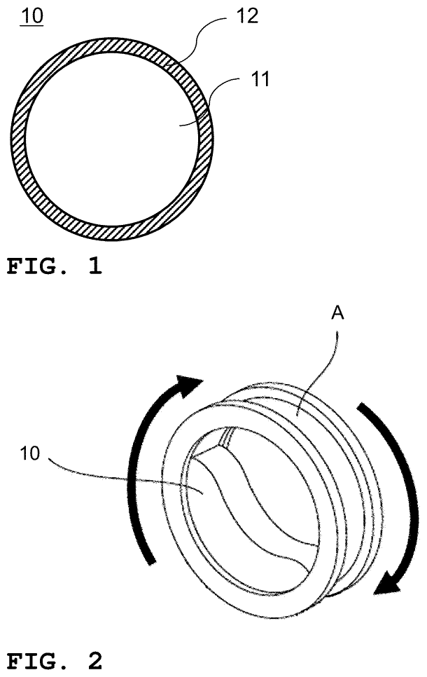

FIG. 1 shows a lithium secondary battery cathode active material according to one embodiment of the present disclosure. The cathode active material 10 may include a core part 11 and a coating layer 12 covering at least a portion of the surface of the core part 11.

The core part 11 may contain one or more compounds represented by Formula 1.

Liₐ(NiₓM1_{y}M2_{z})O₂ [Formula 1]

In Formula 1, M1 may include Co, Mn, Ni, Al, Mg, or Ti; M2 may include Ca, Mg, Al, Ti, Sr, Fe, Co, Mn, Ni, Cu, Zn, Y, Zr, Nb, or B; and a, x, y, and z may satisfy 0<a≤1, 0.75x≤1, 0≤y≤0.3, 0≤z≤0.3, and x+y+z=1.

The core part 11 may be a secondary particle. The secondary particle may refer to a particle resulting from agglomeration of tens to hundreds of primary particles.

The coating layer 12 may cover more than 10%, more than 20%, more than 30%, more than 40%, more than 50%, more than 60%, more than 70%, more than 80%, more than 90%, or more than 99% of the surface of the core part 11.

The coating layer 13 may contain an inorganic compound. The inorganic compound may include LiNbO₃, Li₂ZrO₃, Li₃PO₄, Li₂SiO₃, or combinations thereof.

The thickness of the coating layer 12 is not particularly limited and may be, for example, in a range of 10 nm to 300 nm. When the thickness of the coating layer 12 is less than 10 nm, the initial resistance may increase. On the other hand, when the thickness of the coating layer 12 exceeds 300 nm, the residual lithium may decrease and the effect of increase in capacity may be reduced.

The method of forming the first coating layer 12 is not particularly limited. For example, the coating layer 12 may be formed in a manner that an intermediate may be prepared by applying a precursor of an inorganic compound on the core part 11, and then the intermediate is heat treated. The heat treatment temperature is not particularly limited, and the temperature may be in a range of 200° C. to 800° C. When the heat treatment temperature is less than 200° C., the coating layer 12 may not be properly formed. On the other hand, when the heat treatment temperature exceeds 800° C., the properties of the core part 11 may deteriorate.

The cathode active material may include 90% to 99% by weight of the core part and 1% to 10% by weight of the coating layer.

The average particle diameter (D₅₀) of the cathode active material 10 is not particularly limited and may be, for example, in a range of 1 micrometers (μm) to 10 μm. When the average particle diameter (D₅₀) is less than 1 μm, it may be difficult to form an electrode using the cathode active material 10. On the other hand, when the average particle diameter (D₅₀) exceeds 10 μm, the resistance may increase, and the output power may decrease. The average particle diameter (D₅₀) refers to the particle size at 50% in the volume cumulative distribution of the cathode active material 10. The average particle diameter (D₅₀) can be measured using a laser diffraction method. For example, the average particle diameter (D₅₀) can be obtained through the steps in which a dispersion in which the cathode active material 10 is dispersed is prepared, a volume cumulative particle size distribution graph is obtained by irradiating the dispersion with ultrasonic waves at about 28 kHz and an output power of 60 W using a commercially available laser diffraction particle size measurement device (e.g., Microtrac MT 3000), and the particle size corresponding to 50% of the volume cumulative particle size distribution is measured.

The cathode active material 10 according to the present disclosure has excellent dispersibility, so when an electrode is made of the cathode active material, the electrode may have a reduced internal resistance value, and the lifespan of the battery having the electrode can be increased.

The cathode active material 10 may have a flow angle in a range of 20° to 55°. The flow angle is one of the parameters to evaluate the fluidity of powder. The fluidity refers to the ability of the powder to flow freely and uniformly in the form of individual particles. A relatively small flow angle means that the force of attraction between particles is relatively small and the fluidity of the powder is good.

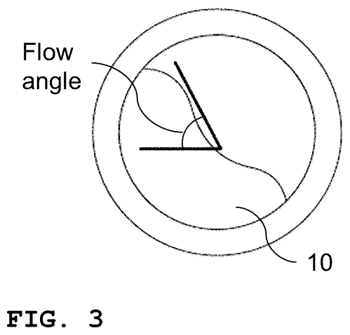

FIG. 2 shows an exemplary device capable of measuring the flow angle. First, a certain amount of cathode active material 10 is put into a cylindrical drum A. The drum A rotates at a constant speed, and as the drum rotates, the layer of the positive electrode active material 10 is pulled upward. Afterwards, an avalanche occurs when the balance between the attraction between the particles of the cathode active material 10 and the gravity of the particles of the positive electrode active material 10 is lost. The avalanche phenomenon that occurs periodically in the rotating drum A is continuously imaged with a digital camera (800×800 pixels). Subsequently, the captured images are analyzed for measurement, and the angle of the slope of the layer of the cathode active material 10 with respect to the ground surface every when the avalanche event occurs as shown in FIG. 3 can be taken as the value of the flow angle. A device capable of measuring the flow angle may be, for example, a GranuDruM™ powder rheometer, and the results may be analyzed with GranuTools™ software.

The rotation speed of the drum A is not particularly limited, and for example, the drum A may rotate in a range of 1 rpm to 70 rpm.

The digital camera can image the cathode active material 10 at intervals in a range of 500 ms to 1,000 ms.

When the cathode active material 10 is put into a drum A rotating at 10 rpm and imaged 50 times at intervals of 1,000 ms using a digital camera, the flow angle of the cathode active material 10 may be in a range of 20° to 55°.

The cathode active material 10 may have a cohesive index in a range of 10 to 20. The cohesion index refers to an index of the cohesion between particles of the cathode active material 10 while the cathode active material 10 flows. The lower the cohesive index, the higher the dispersibility.

The cohesion index can be defined as follows using the flow angle and the change in the interface between air and the cathode active material rotating at a fixed speed within the drum A.

Avalanche events that occur periodically in the rotating drum A are continuously imaged in the same manner as the measurement of the flow angle using a digital camera (with 800×800 pixels).

Using the images, the average value of the interface between the cathode active material and the air in the drum A is calculated, and then the standard deviation σ(x) of the average value is calculated for each pixel. The values of the standard deviation for the respective pixels are all added, and the average thereof is obtained, and the obtained average is used as the cohesive index. Specifically, the standard deviation and the cohesive index can be calculated by the following expressions, and more details can be found in Powder Technology, 224 (2012) 19-27.

$$σ ( x ) = √ \frac{{\sum }_{i = 0}^{{N}_{y} ( x )} {( \overline{y} ( x ) - {y}_{i} ( x ) )}^{2}}{{N}_{y} ( x )}$$

$$Cohesive Index ( CI ) = \frac{1}{Dcrop} {\sum }_{x} σ ( x )$$

In the above formula, N_{y}(x) is the number of y-axis coordinates corresponding to the x-axis coordinate of the average interface.
σ(x) is the standard deviation of the x-axis coordinate.
y̅(x) is the x-axis coordinate of the average interface.
yᵢ(x) is the y-axis coordinate corresponding to the x-axis coordinate of the average interface.
N is the number of captured images.
nᵢ is the number of pixels at the interface between the air and the cathode active material.

The flow angle is measured by putting the cathode active material into the drum A rotating at 10 rpm, imaging the cathode active material 50 times at intervals of 1,000 ms using a digital camera, and obtaining the average of the flow angles measured. In this case, the cohesive index calculated on the basis of the average of the flow angles and variations in change of interface between the air and the cathode active material 10 may be in a range of 10 to 20.

The cathode active material 10 may have a roughness index in a range of 1.30 to 1.50. Specifically, the roughness index may be an index of the irregularity of the interface between the air and the cathode active material 10. The closer value of the roughness index to 1, the closer to the characteristic (e.g., smoother surface) of a non-cohesive powder. As the roughness index increases, the change in the interface increases, indicating that the surface is irregular.

The roughness index can be calculated by the following expression, and more details can be found in International Journal of Pharmaceutics 494 (2015) 312-320:

$$Roughness index ( RI ) = \frac{1}{Dcrop} \frac{1}{N} {\sum }_{l = 1}^{N} {n}_{l}$$

In the above formula, nₗ is the average value of the number of pixels forming the interface between the air and the cathode active material.

The coefficient of surface friction 10 may have a coefficient of surface friction in a range of 0.8 to 1.2. The surface friction coefficient may refer to an interparticle friction index calculated from the flow angle. The lower the surface friction coefficient, the better the fluidity.

The surface friction coefficient can be calculated by the following expression using the flow angle (θ), and more details thereof can be found in International Journal of Pharmaceutics 494 (2015) 312-320:

Surface friction coefficient (μ)=height (h)/radius (r)=tan θ

Hereinafter, the present disclosure is described in greater details with reference to examples. The following examples are presented only to aid in understanding of the present disclosure and are not intended to limit the scope of the disclosure.

### Examples 1 to 7 and Comparative Example

Nickel-cobalt-manganese-based lithium metal oxide was prepared as a core part. A coating layer with the composition and content shown in Table 1 below was formed on the surface of the core part. Specifically, a precursor of a target compound was applied to the surface of the core part to obtain an intermediate, and then the intermediate was heat-treated at about 350° C. to form a coating layer.

In the Comparative Example, no coating layer was formed.

TABLE 1

| | Composition | Content of |
|---|---|---|
| | of coating | coating layer |
| Classification | layer | [% by weight ] |
| Comparative | — | — |
| Example | | |
| Example 1 | LiNbO₃ | 1.4 |
| Example 2 | Li₂ZrO₃ | 1.4 |
| Example 3 | Li₃PO₄ | 1.4 |
| Example 4 | Li₂SiO₃ | 1.4 |
| Example 5 | Li₂SiO₃ | 2.8 |
| Example 6 | Li₂SiO₃ | 4.2 |
| Example 7 | Li₂SiO₃ | 5.6 |

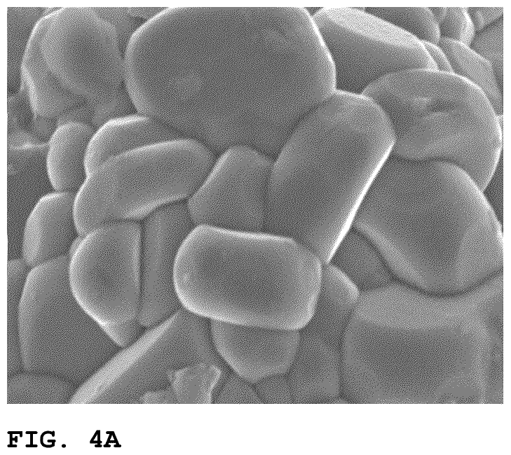

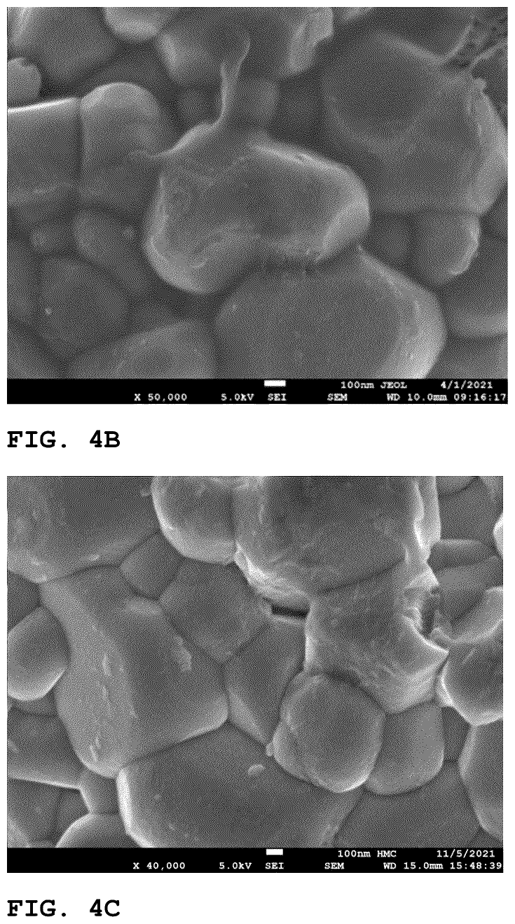

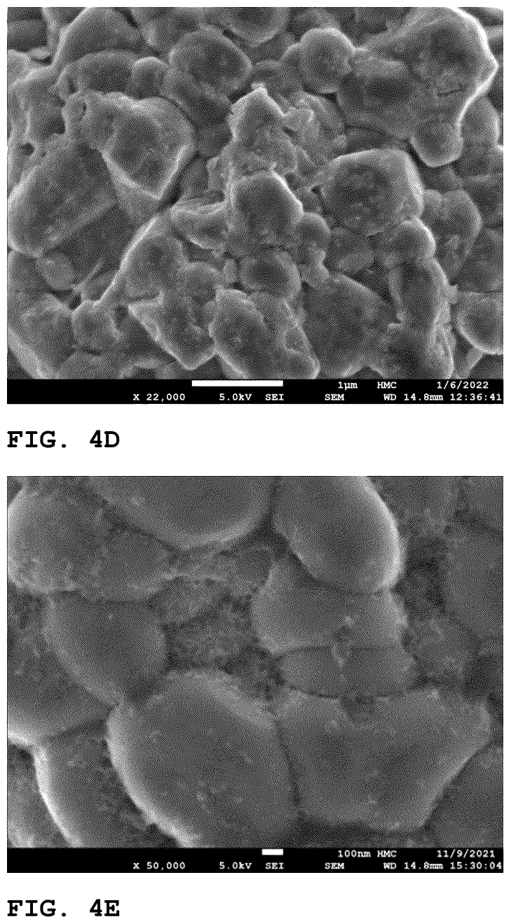

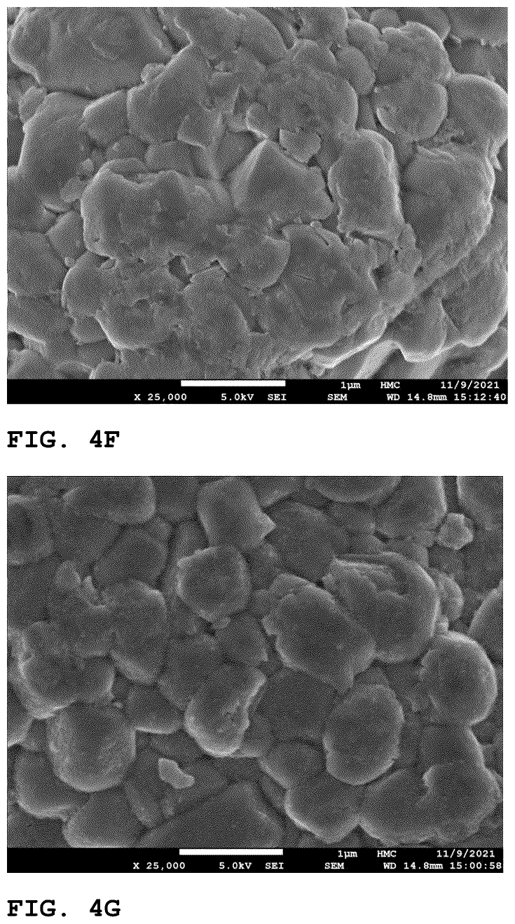

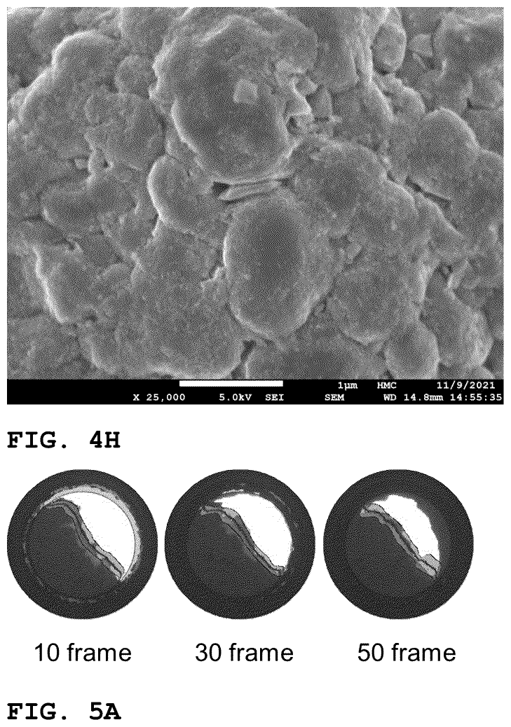

FIG. 4A shows an SEM analysis result of a cathode active material according to Comparative Example; FIG. 4B shows an SEM analysis result of a cathode active material according to Example 1; FIG. 4C shows an SEM analysis result of a cathode active material according to Example 2; FIG. 4D shows an SEM analysis result of a cathode active material according to Example 3; FIG. 4E shows an SEM analysis result of a cathode active material according to Example 4; FIG. 4F shows an SEM analysis result of a cathode active material according to Example 5; FIG. 4G shows an SEM analysis result of a cathode active material according to Example 6; FIG. 4H shows an SEM analysis result of a cathode active material according to Example 7.

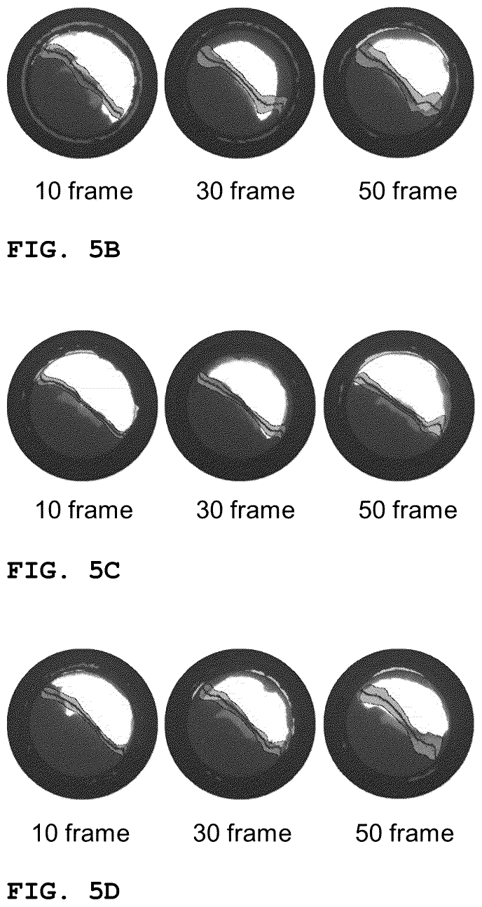

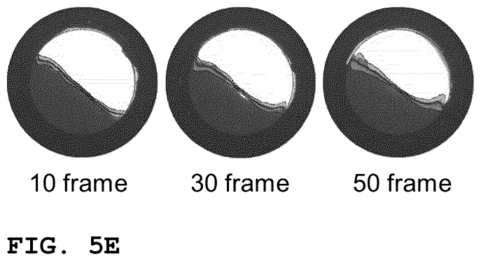

Each cathode active material according to Examples 1 to 7 and Comparative Example was charged into a drum A illustrated in FIG. 2. The drum A had a capacity of 20 ml, and about 10 ml of the cathode active material was put into the drum A. With the drum A rotating at a speed of 10 rpm, the cathode active material was imaged 50 times at intervals of 1,000 ms using a digital camera to measure the flow angle. FIG. 5A shows a flow angle measurement result of a cathode active material according to Comparative Example; FIG. 5B shows a flow angle measurement result of the cathode active material according to Example 1; FIG. 5C shows a flow angle measurement result of the cathode active material according to Example 2; FIG. 5D shows a flow angle measurement result of the cathode active material according to Example 3; and FIG. 5E shows a flow angle measurement result of the cathode active material layer according to Example 4.

The results are summarized in Table 2.

TABLE 2

| | Flow | | | Surface |
|---|---|---|---|---|
| | angle | Cohesive | Roughness | friction |
| Classification | [ °] | index | index | coefficient |
| Comparative | 54.25 | 20.43 | 1.51 | 1.389282 |
| Example | | | | |
| Example 1 | 44.96 | 14.24 | 1.47 | 0.998601 |
| Example 2 | 41.76 | 11.81 | 1.40 | 0.892892 |
| Example 3 | 40.20 | 10.27 | 1.50 | 0.845006 |
| Example 4 | 42.36 | 13.39 | 1.50 | 0.911993 |
| Example 5 | 41.37 | 12.46 | 1.36 | 0.880688 |
| Example 6 | 41.16 | 15.53 | 1.39 | 0.874297 |
| Example 7 | 40.30 | 14.68 | 1.37 | 0.847951 |

With the use of each of the cathode active materials according to Examples 1 to 7 and Comparative Example, all-solid-state batteries each including a cathode active material layer, a solid electrolyte layer, and an anode active material layer stacked in order were manufactured. The composition of each layer, the content of each component of the composition, and the manufacturing method were all the same.

The results electrochemical properties of each all-solid-state battery are summarized in Table 3. The measurement methods and measurement conditions for each physical property were all the same.

TABLE 3

| | | | Capacity |
|---|---|---|---|
| | | | retention rate |
| | DC-IR | Capacity | (@50 cycles) |
| Classification | [Ω] | (mAh/g) | [%] |
| Comparative | 16.9 | 184 | 58.6 |
| Example | | | |
| Example 1 | 11.8 | 197.1 | 91.7 |
| Example 2 | 11.4 | 195 | 89.1 |
| Example 3 | 20.9 | 186.7 | 79.3 |
| Example 4 | 20.1 | 194.8 | 82.3 |
| Example 5 | 22.1 | 193.1 | 92.8 |
| Example 6 | 24.6 | 186.7 | 94.5 |
| Example 7 | 20.9 | 185.8 | 64.5 |

The results of Examples 1 to 4 confirmed that when the flow angle, cohesion index, roughness index, and surface friction coefficient suggested by the present disclosure are satisfied, the capacity and capacity retention rate were improved compared to the comparative example regardless of the type of coating layer. The results of Examples 1 and 2 confirmed that the electrical resistance of the electrodes was reduced compared to the comparative example.

The results of Examples 1 to 4 confirmed that when the flow angle, cohesion index, roughness index, and surface friction coefficient suggested by the present disclosure are satisfied, the capacity and capacity retention rate were improved regardless of the content of the coating layer.

While exemplary embodiments of the present disclosure have been described with reference to the accompanying drawings, those skilled in the art will appreciate that the present disclosure can be implemented in other different forms without departing from the technical spirit of essential characteristics of the present disclosure. Therefore, it should be understood that the exemplary embodiments described above are only for illustrative purposes and are not restrictive in all aspects.

What is claimed is:

1. A cathode active material for a lithium secondary battery, the cathode active material comprising:
a core part comprising a lithium metal oxide; and
a coating layer covering at least a portion of a surface of the core part and comprising an inorganic compound.

2. The cathode active material of claim 1, wherein the cathode active material has a flow angle in a range of 20° to 55°.

3. The cathode active material of claim 1, wherein the cathode active material has a cohesive index in a range of 10 to 20.

4. The cathode active material of claim 1, wherein the cathode active material has a roughness index in a range of 1.30 to 1.50.

5. The cathode active material of claim 1, wherein the cathode active material has a coefficient of surface friction in a range of 0.8 to 1.2.

6. The cathode active material of claim 1, wherein the cathode active material has a flow angle in a range of 20° to 55°, a cohesive index of 10 to 20, a roughness index in a range of 1.30 to 1.50, and a coefficient of surface friction in a range of 0.8 to 1.2.

7. The cathode active material of claim 1, wherein the lithium metal oxide is represented by Liₐ(NiₓM1_{y}M2_{z})O₂,
wherein M1 comprises Co, Mn, Ni, Al, Mg, or Ti,
wherein M2 comprises Ca, Mg, Al, Ti, Sr, Fe, Co, Mn, Ni, Cu, Zn, Y, Zr, Nb, or B, and
wherein 0<a≤1, 0.7≤x≤1, 0≤y≤0.3, 0≤z≤0.3, and x+y+z=1 are satisfied.

8. The cathode active material of claim 1, wherein the coating layer comprises LiNbO₃, Li₂ZrO₃, Li₃PO₄, Li₂SiO₃, or combinations thereof.

9. The cathode active material of claim 1, wherein the cathode active material comprises 90% to 99% by weight of the core part and 1% to 10% by weight of the coating layer.
